(19) United States
(12) Patent Application Publication
(10) Pub. No.: US 2019/0026402 A1
(43) Pub. Date: Jan. 24, 2019

(54) GENERATIVE SPACE PLANNING IN ARCHITECTURAL DESIGN FOR EFFICIENT DESIGN SPACE EXPLORATION

(71) Applicant: AUTODESK, INC., San Rafael, CA (US)

(72) Inventors: David BENJAMIN, New York, NY (US); James STODDART, New York, NY (US); Danil NAGY, New York, NY (US); Lorenzo VILLAGGI, New York, NY (US)

(21) Appl. No.: 15/956,689

(22) Filed: Apr. 18, 2018

Related U.S. Application Data
(60) Provisional application No. 62/535,756, filed on Jul. 21, 2017.

(51) Int. Cl. G06F 17/50

(52) U.S. Cl. CPC G06F 17/5004; G06F 2217/04; G06F 2217/06

(57) ABSTRACT

A design engine generates a spectrum of design options to solve an architectural design problem. When generating a given design option, the design engine processes a set of design objectives and design constraints to generate an initial design plan. The initial design plan defines generative regions where geometry can be created and non-generative regions where geometry creation is restricted. The design engine generates a set of pathways that divide the design plan into multiple parcels and then divides each parcel further to produce a collection of cells. The design engine selects specific cells for major programs and merges these cells with adjacent cells until program space requirements are met. The design engine distributes minor programs within the remaining unoccupied cells of the design plan, thereby producing the design option.

### CROSS-REFERENCE TO RELATED APPLICATIONS

This application claims the benefit of United States provisional patent application titled, “A Novel Design Space Model for Generative Space Planning in Architecture,” filed on Jul. 21, 2017 and having Ser. No. 62/535,756. The subject matter of this related application is hereby incorporated herein by reference.

### BACKGROUND

### Field of the Various Embodiments

The various embodiments relate generally to computer-aided design and, more specifically, to generative space planning in architectural design for efficient design space exploration.

### Description of the Related Art

In the field of architecture, the term “space planning” refers to the task of organizing a physical space to facilitate various activities. For example, in designing an office building, a designer would generate a floor layout defining the locations of hallways, the positions of cubicles and desks, the arrangement of conference rooms, and so forth. With conventional approaches to space planning, the designer first determines a set of design objectives and a set of design constraints associated with the physical space to be organized. To perform this task, the designer typically interacts with stakeholders in the physical space to determine planned usage, analyze construction limitations, and conduct other research intended to establish context for organizing the space.

Once this context is established, the designer then makes a sequence of design decisions to produce a design. As a general matter, these design decisions progress from broad decisions that influence the design as a whole, to narrower decisions that are more focused on smaller details of the design. These narrower decisions generally depend on the previous, broader decisions. For example, the designer could initially select a specific geometrical shape for the floor layout of the design. Subsequently, the designer would organize various fixtures within the design in a manner that depends on the previously selected geometrical shape. Designers typically rely on intuition and heuristics to guide this decision making process. However, this design approach leads to specific problems.

In particular, designers oftentimes make early design decisions based on intuition and heuristics that artificially constrain the design space associated with the design. For example, if the designer initially were to decide to organize the hallways of the design to be orthogonal to one another, then the designer would not subsequently consider any designs with non-orthogonal hallways. A consequence of making early design decisions is that numerous possible designs are excluded from the design process. In a similar vein, a consequence of using intuition and heuristics early in the design process is that designers, over time, oftentimes produce numerous similar designs that are derived from the same intuitive feelings and/or set of habitually applied heuristics. This phenomenon is known in the art as “design fixation.” Continually producing similar designs inhibits designers from producing a multitude of different designs to address the wide variety of different design problems to which designers are typically exposed.

As the foregoing illustrates, what is needed in the art are more effective techniques for exploring design spaces.

### SUMMARY

Various embodiments include a computer-implemented method for automatically generating design options for an architectural space, including generating a design plan based a set of design criteria, wherein the design plan indicates generative regions where geometry can be placed and non-generative regions where geometry cannot be placed, projecting one or more pathways across the design plan according to a first set of parameters to define a set of parcels, subdividing each parcel into a plurality of cells, projecting a seed point onto a first cell included in the plurality of cells based on a second set of parameters, expanding the first cell until a first area criterion is met to produce a first design option, wherein the first design option maximizes at least one design objective included in the set of design criteria compared to another design option.

At least one advantage of the disclosed techniques is that the design engine does not implement conventional heuristics and therefore avoids making early design decisions that overly constrain the design space. Accordingly, the design engine can explore the design space associated with the design problem more exhaustively compared to prior art techniques. In addition, because the design engine does not implement conventional heuristics, the design engine avoids producing overly similar designs that may be ill suited for the diverse types of problems typically found in architecture. These advantages represent substantial technological improvements over prior art approaches to design exploration.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments;

FIG. 2 is a more detailed illustration of the design engine of FIG. 1, according to various embodiments;

FIG. 3 illustrates how an initial design plan is generated, according to various embodiments;

FIG. 4 illustrates how the design plan of FIG. 3 is divided into parcels, according to various embodiments;

FIG. 5 illustrates how the parcels of FIG. 4 are divided into cells, according to various embodiments;

FIG. 6 illustrates how program seed points are assigned to the cells of FIG. 5, according to various embodiments;

FIG. 7 illustrates how cells are merged based on the program seed points of FIG. 6, according to various embodiments;

FIG. 8 illustrates how minor programs are distributed across the non-merged cells of FIG. 7 to generate a design option, according to various embodiments;

FIG. 9 is a flow diagram of method steps for automatically generating design options to address a design problem, according to various embodiments;

FIG. 10 illustrates a data structure that defines cells within an initial design plan, according to various embodiments;

FIG. 11 illustrates how the data structure of FIG. 10 is modified in order to subdivide a design plan, according to various embodiments;

FIG. 12 illustrates how the neighbors of a cell are detected based on the data structure of FIG. 11, according to various embodiments;

FIG. 13 illustrates how the data structure of FIG. 12 is modified in order to merge one cell with another cell, according to various embodiments; and

FIG. 14 is a flow diagram of method steps for allocating space to programs within a design plan, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

As noted above, with conventional approaches to space planning, designers oftentimes make early design decisions based on intuition and heuristics. These early design decisions can artificially narrow the design space, potentially excluding numerous feasible designs. In addition, applying the same intuition and heuristics can cause designers to habitually generate similar designs. This phenomenon is known as “design fixation.” Design fixation is problematic because designers face a wide variety of design problems that cannot all be addressed by the same type of design.

To address these issues, embodiments of the invention include a design engine configured to generate a spectrum of design options that resolve an architectural design problem associated with space planning. When generating a given design option, the design engine processes a set of design objectives and design constraints to generate an initial design plan. The initial design plan defines generative regions where geometry can be created and non-generative regions where geometry creation is restricted. The design engine generates a set of pathways that divide the design plan into multiple parcels and then divides each parcel to produce a collection of cells. The design engine assigns specific cells to major programs where activities are to be performed, and then merges these cells with adjacent cells until program space requirements are met. The design engine distributes minor programs within the remaining unoccupied cells of the design plan, thereby producing the design option. To perform the above-described division and merging operations, the design engine implements a novel data structure that permits rapid subdivision and merging of geometrical spaces without performing computationally costly geometry operations.

At least one advantage of the techniques is that the design engine does not implement conventional heuristics and therefore avoids making early design decisions that overly constrain the design space. Accordingly, the design engine can explore the design space associated with the design problem more exhaustively compared to prior art techniques. In addition, because the design engine does not implement conventional heuristics, the design engine avoids producing overly similar designs that may be ill suited for the diverse types of design problems typically found in architectural space planning. These advantages represent substantial technological improvements over prior art approaches to design exploration.

### System Overview

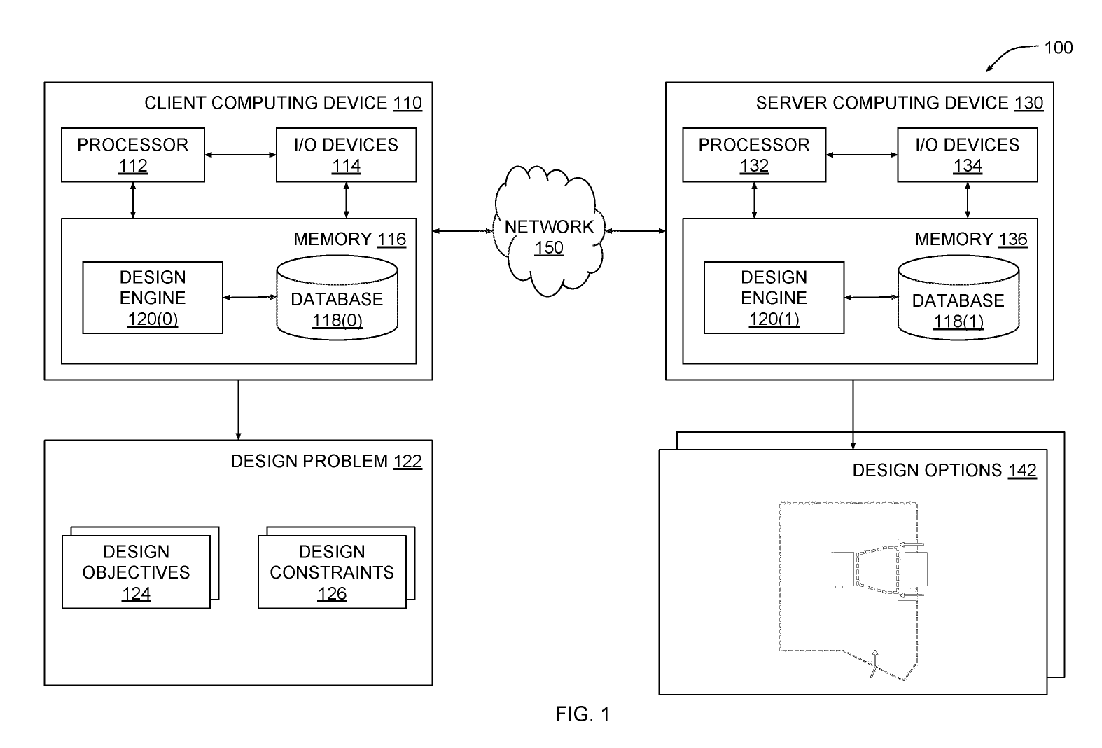

FIG. 1 illustrates a system configured to implement one or more aspects of the present embodiments. As shown, a system 100 includes a client computing device 110 coupled to a server computing device 130 via a network 150.

Client computing device 110 includes a processor 112, input/output (I/O) devices 114, and a memory 116, coupled together. Processor 112 includes any technically feasible set of hardware units configured to process data and execute software applications. For example, processor 112 could include one or more of a central processing unit (CPU), a graphics processing unit (GPU), and an application specific integrated circuit (ASICs). I/O devices 114 include any technically feasible set of devices configured to perform input and/or output operations, including, for example, a display device, a keyboard, a mouse, and a touchscreen, among others. Memory 116 includes any technically feasible set of storage media configured to store data and software applications, such as a hard disk, a random-access memory (RAM) module, and a read-only memory (ROM), for example. Memory 116 includes a database 118(0) and a design engine 120(0). Design engine 120(0) is a software application that, when executed by processor 112, interoperates with a corresponding design engine executing on server computing device 130, as described in greater detail below.

Server computing device 130 includes a processor 132, I/O devices 134, and memory 136, coupled together. Processor 132 includes any technically feasible set of hardware units configured to process data and execute software applications. I/O devices 134 include any technically feasible set of devices configured to perform input and/or output operations. Memory 136 includes any technically feasible set of storage media configured to store data and software applications. Memory 136 includes a database 118(1) and a design engine 120(1). Design engine 120(1) is a software application that, when executed by processor 132, interoperates with design engine 120(0) to automatically generate design options that address an architectural design problem.

As a general matter, design engine 120(0) and design engine 120(1) interoperate to implement any and all of the inventive functionality described herein and therefore may be considered to represent different portions of single distributed software entity. Thus, for simplicity, design engines 120(0) and 120(1) are referred to hereinafter collectively as design engine 120. Similarly, databases 118(0) and 118(1) represent different portions of a single distributed storage entity. Therefore, for simplicity, databases 118(0) and 118(1) may be referred to collectively as database 118.

In operation, design engine 120 generates a design problem 122 based on input received from an end-user. Design problem 122 is generally associated with an architectural space planning project. In some of the examples described herein, the architectural design project relates to the layout of programs at an exposition. However, the techniques described herein are more generally applicable to any design project meant to organize any human activity within a spatial environment.

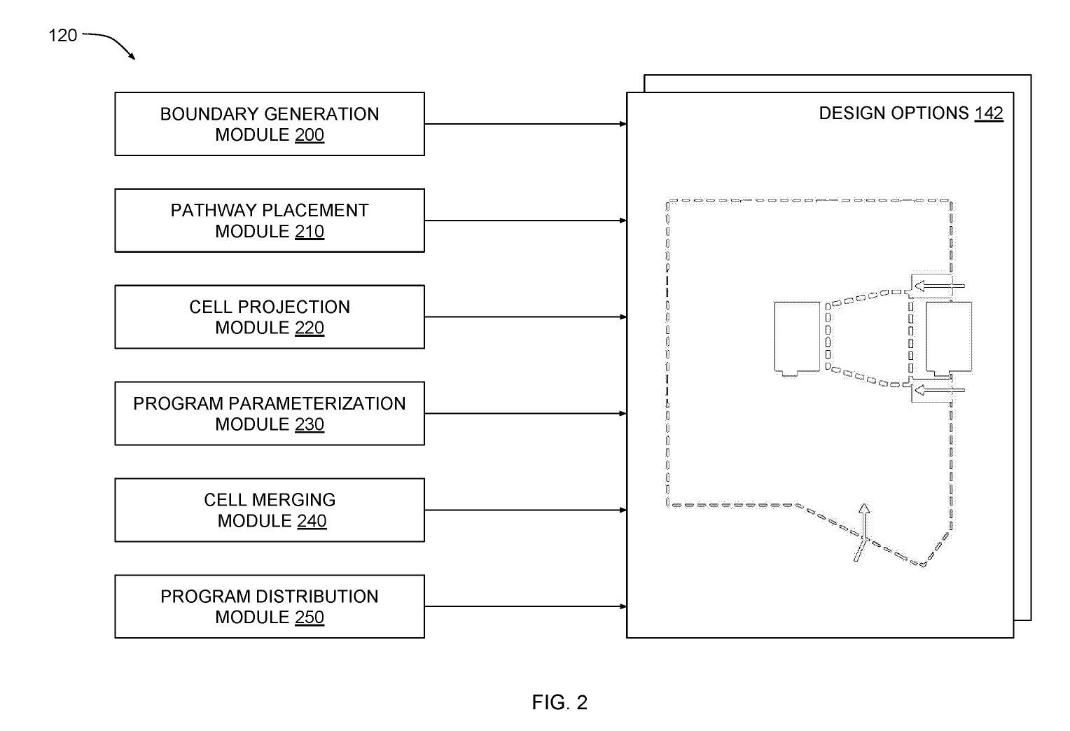

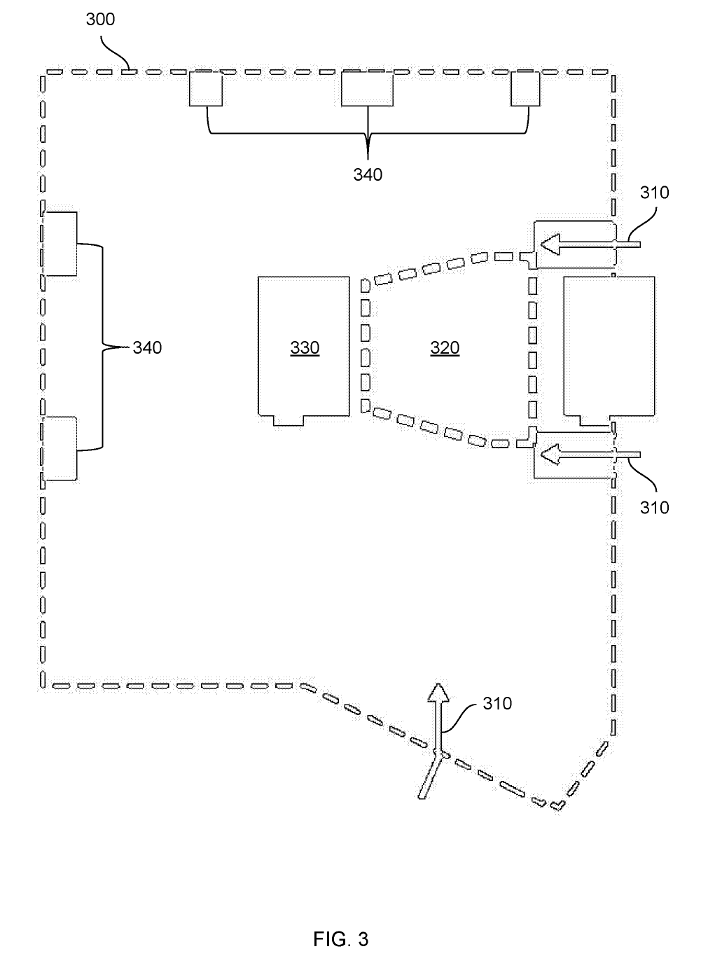

Design problem 122 includes one or more design objectives 124 and one or more design constraints 126. A given design objective 124 indicates a criterion that should be met or maximized by any design generated to address design problem 122. A given design constraint 126 indicates a criterion that should not be violated by any design generated to address design problem 122. Design engine 120 processes design problem 122 and then generates a spectrum of design options 142. In doing so, design engine 120 parameterizes the design space associated with design problem 122 and then generates different design options 142 having different combinations of parameters. This process is performed in a procedural manner that is described in greater detail below in conjunction with FIG. 2, and also described by way of example in conjunction with FIGS. 3-8.

FIG. 2 is a more detailed illustration of the design engine of FIG. 1, according to various embodiments. As shown, design engine 120 includes a boundary generation module 200, an avenue placement module 210, a cell projection module 220, a program parameterization module 230, a cell merging module 240, and a program distribution module 250. The various modules of design engine 120 interoperate to procedurally generate design options 142.

A given design option 142 describes a particular distribution of different types of pathways and different types of programs. In the context of this disclosure a “pathway” relates to any linear or curvilinear space where an entity can travel. For example, when design problem 122 relates to the layout of booths at an exposition, then the various avenues between booths would be considered pathways because these avenues are spaces where humans can walk. Pathways generally run between programs in any given design option 142 and provide a means of travel between those programs. In the context of this disclosure, a “program” refers to any static location where activities may be performed. Returning to the above example, a “program,” as related to an exposition, could be a recruiting table, a demo booth, or a corporate tent, among others. The modules of design engine 120 generate geometry representing the distribution of these pathways and programs, as described in greater detail below.

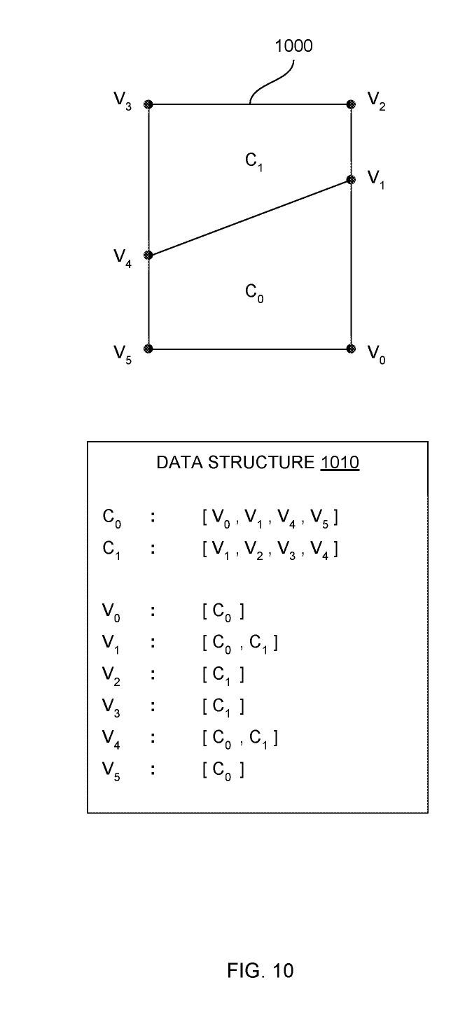

Boundary generation module 200 processes design problem 122 and then generates an initial design plan defining boundaries within which elements of a design option can be generated. The design plan may include a set of boundaries defining generative regions where geometry can be generated and non-generative regions where geometry cannot be generated. Pathway placement module 210 places one or more major pathways within the generative regions of the design plan, thereby dividing the design plan into a set of parcels. In addition, pathway placement module 210 may also generate one or more minor pathways derived from the different major pathways to generate additional parcels. Cell projection module 220 divides these parcels to create multiple cells. In one embodiment, pathway placement module 210 and cell projection module 220 implement a technique described below in conjunction with FIGS. 10-14 to subdivide portions of design plan 300.

Program parameterization module 230 then distributes individual programs to specific cells generated via cell projection module 220. Program parameterization module 230 distributes a given program to a specific cell by parameterizing the position of the given program. Specifically, program parameterization module 230 generates a set of parameters indicating a particular pathway and a position along that pathway where the program is to be located. Program parameterization module 230 then identifies the particular cell corresponding to that position. Program parameterization module 230 may also parameterize the position of specific programs based on design constraints 126. For example, when parameterizing the position of a food and beverage program, program parameterization module 230 could constrain the position of that program to only reside at an endpoint of a given pathway. Program parameterization module 230 typically performs the above technique for major programs that require elevated exposure and/or space compared to other programs.

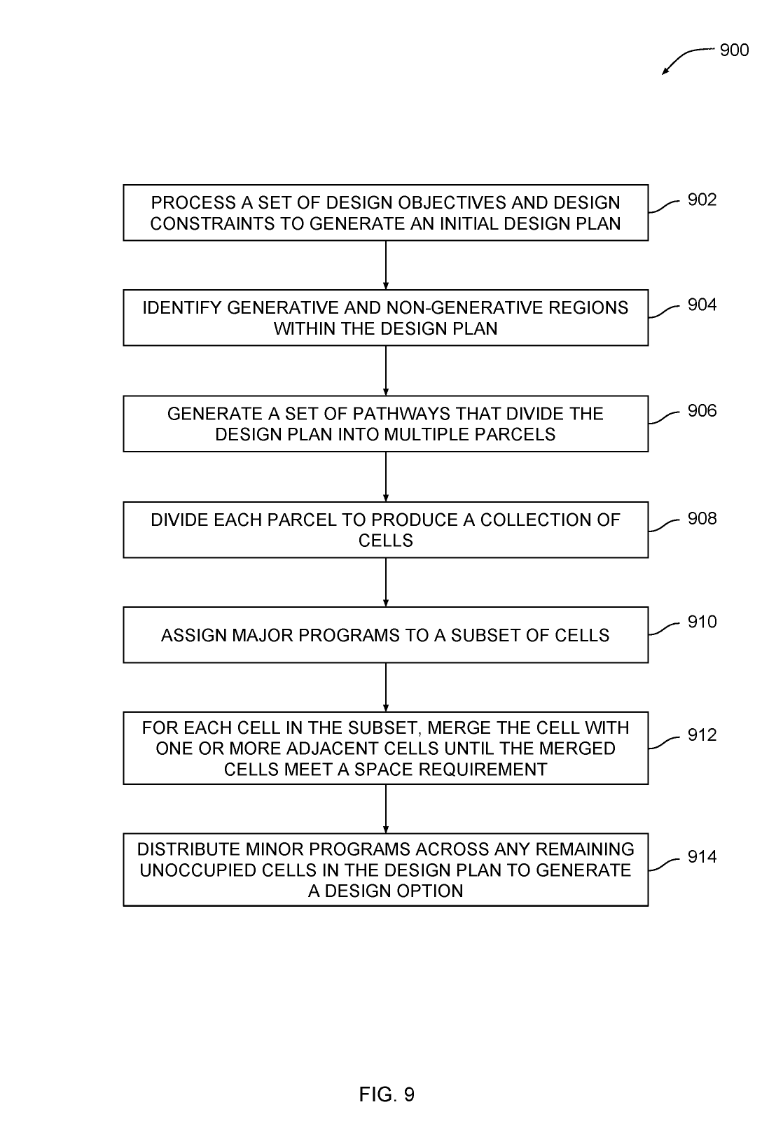

Cell merging module 240 merges each cell to which a program has been distributed with one or more adjacent cells in order to allocate sufficient space to that program. For a given cell, cell merging module 240 merges the cell with at least one adjacent cell repeatedly until an area requirement associated with the program corresponding to the cell is met. In this manner, programs assigned to particular cells via program parameterization module 230 are allocated an appropriate amount of space. In one embodiment, cell merging module 240 implements a technique described below in conjunction with FIGS. 9-13 to perform the cell merging process. Once cell merging is complete, program distribution module 250 distributes any remaining programs across some or all of the remaining unoccupied cells. These remaining programs may constitute minor programs that require less space (or a fixed amount of space) compared to the major programs already distributed.

Through the procedure described above, design engine 120 generates geometry representing a given design option 142. This geometry depends on two unique sets of parameters associated with the design option 142 that, conceptually, act to “seed” geometry generation. The first set of parameters includes M discrete parameters that guide pathway placement (M being an integer). In one embodiment, these M parameters include three floating point numbers in the domain [0.0, 1.0] which dictate the end point of one pathway as a percentage of the length of the wall opposite of one of three main entrances into the space. A second set of parameters includes N discrete parameters that guide program placement (N being an integer). In one embodiment, these N parameters include 11 integer numbers in the range [0,2] which dictate on which of the three main pathways each of 11 key program areas will be placed. A second set of 11 floating point numbers in the range [0.0-1.0] dictate the exact placement of the key programs as a percentage of the length of the pathways (for example, a value of 0.0 places the program at the beginning of the path, a value of 1.0 places it at the end, and a value of 0.5 places it in the middle). Collectively, these two sets of parameters define an M+N dimensional design space (25-dimensional in the case outlined here). A particular combination of choices for these M and N parameters defines a position within that design space corresponding to a specific design option 142.

Design engine 120 is configured to compute various metrics associated with a given design option 142 and then explore that design space based on the computed metrics. These metrics could indicate, for example, a level of circulation provided by the distribution of pathways within a given design option 142, a level of exposure provided to each program within a given design option 142, and so forth. Based on the metrics, design engine 120 may perform an iterative optimization process to generate additional design options 142. Design engine 120 could, for example, implement a genetic algorithm to generate a sequence of generations of design options 142, where each generation includes incrementally mutated sets of parameters. In another example, design engine 120 could execute a multi-objective solver to generate design options 142 which optimize design objectives 124 with respect to design constraints 126. In this manner, design engine 120 may generate design options 142 which optimally meet the design criteria included in design problem 122. FIGS. 3-8 set forth one example of how the techniques described thus far can be applied to generate design options related to the organization of an exposition.

### Exemplary Generation of a Design Option

FIG. 3 illustrates how an initial design plan is generated, according to various embodiments. Design engine 120 generates initial design plan 300 based on design objectives 124 and design constraints 126. Design plan 300 defines an outer boundary within which geometry can be generated to represent various pathways and programs. As shown, design plan 300 includes ingress/egress routes 310, designated program space 320, core space 330, and designated program spaces 340.

Ingress/egress routes 310 include entrances, exits, fire exits, stairwells, and other points of access. Designated program spaces 320 and 340 include space already assigned to a given program. Designated program space 320 may be assigned to a central program designated to occupy a central location in design plan 300, while designated program spaces 340 may be assigned to peripheral programs designated to reside at the boundaries of design plan 300. Core space 330 includes a dedicated empty area. Ingress/egress routes 310, core space 330, and designated program spaces 320 and 340 define non-generative regions of design plan 300. The remaining areas of design plan 300 constitute generative regions where pathways and programs can be placed. Once design plan 300 is initially generated in the manner discussed above, design engine 120 then divides that design plan into parcels by placing pathways.

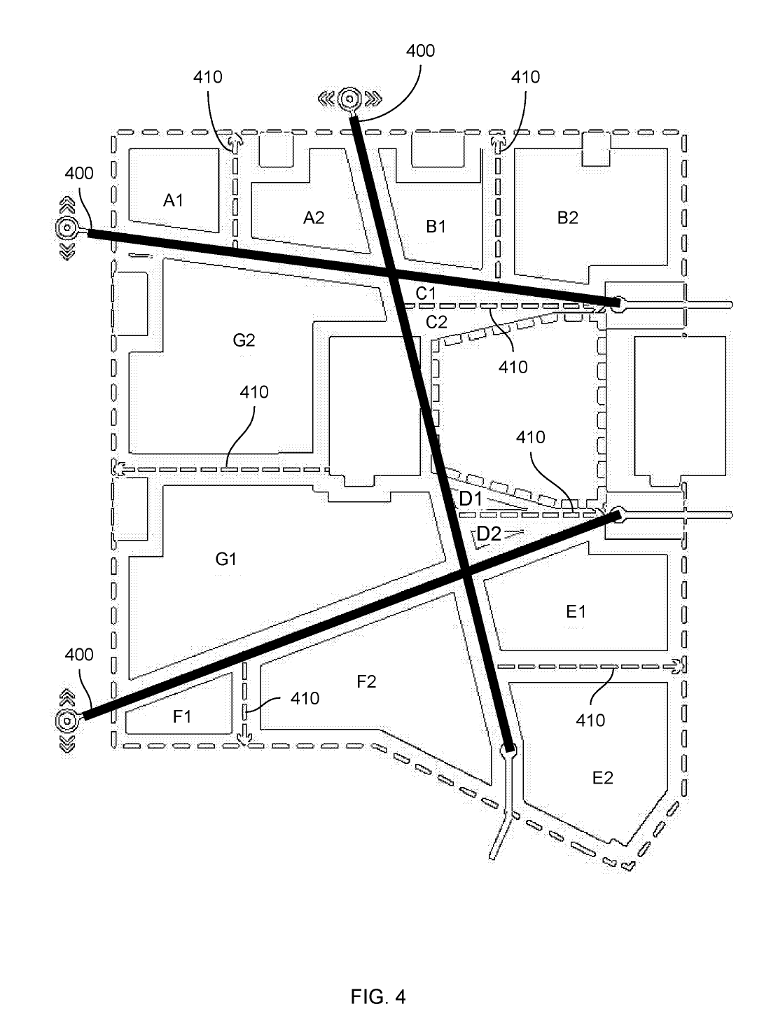

FIG. 4 illustrates how the design plan of FIG. 3 is divided into parcels, according to various embodiments. As shown, design plan 300 includes major pathways 400 that transect design space 300, as well as minor pathways 410 that branch off of major pathways 400. Design engine 120 generates major pathways 400 by generating line segments that connect ingress/egress routes 310 to opposing boundaries of design plan 300 at specific locations. Major pathways 400 divide design plan 300 into macro-regions that are then further subdivided by minor pathways 410 into parcels. Design engine 120 generates minor pathways 410 by performing the following steps.

First, design engine 120 identifies macro-regions that share at least one edge with the outer boundary of design plan 300. Then, for each identified macro-region, design engine 120 identifies the longest edge of the macro-region that is shared with the outer boundary of design plan 300. Design engine 120 determines the midpoint of the identified edge and then generates a minor pathway 410 coupling the determined midpoint to the opposing side of the macro-region, thereby dividing the macro-region into two parcels. Any remaining macro-regions not divided in this manner are designated as parcels. Design engine 120 performs the above process to generate parcels A1, A2, B2, B2, C1, C2, and so forth. Design engine 120 may implement a unique data structure to facilitate the above process, as described in greater detail below in conjunction with FIGS. 10-14.

As a general matter, the generation major pathways 400 and minor pathways 410 for a given design option 142 is controlled by the set of N parameters associated with pathway placement, as discussed above. Once design engine 120 divides design plan 300 into parcels, design engine 120 then further divides those parcels into cells.

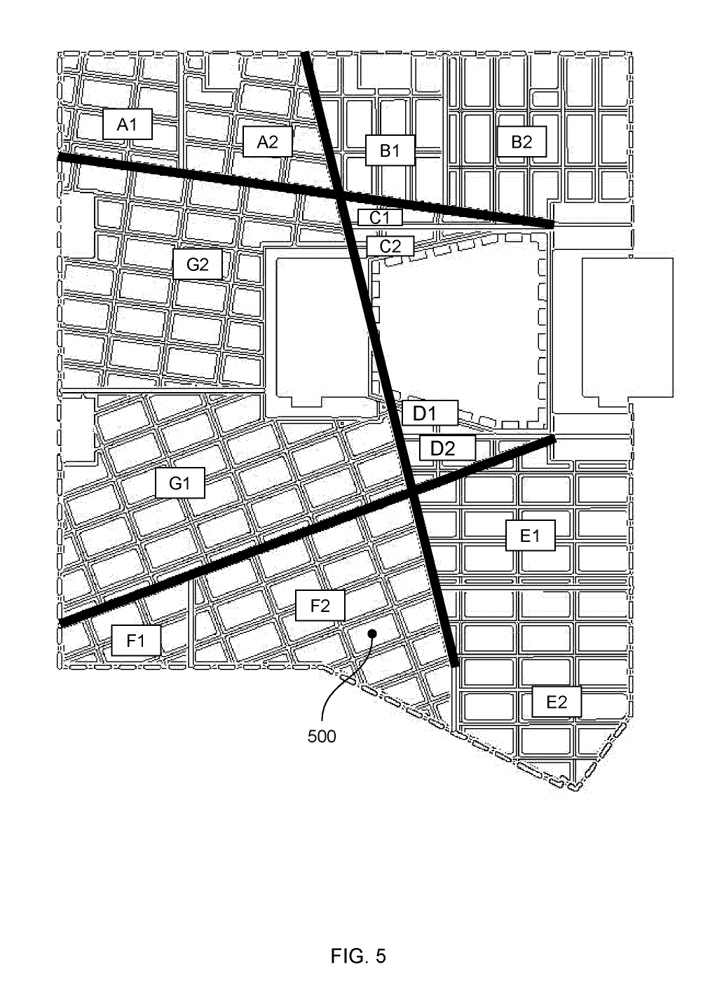

FIG. 5 illustrates how the parcels of FIG. 4 are divided into cells, according to various embodiments. As shown, a rectangular grid of cells is projected within each parcel. For simplicity, just one exemplary cell 500 is shown. Design engine 120 orients a given grid of parcels by aligning the grid to the longest boundary of the parcel. Cells 500 overlapping a parcel boundary are truncated in the manner shown. The dimensions of each cell 500 are configurable and may be dictated by design constraints 126. Design engine 120 implements the above-mentioned data structure to divide parcels, as described in greater detail below in conjunction with FIGS. 10-14. After the parcels are divided into cells, design engine 120 generates seed points for placing major programs.

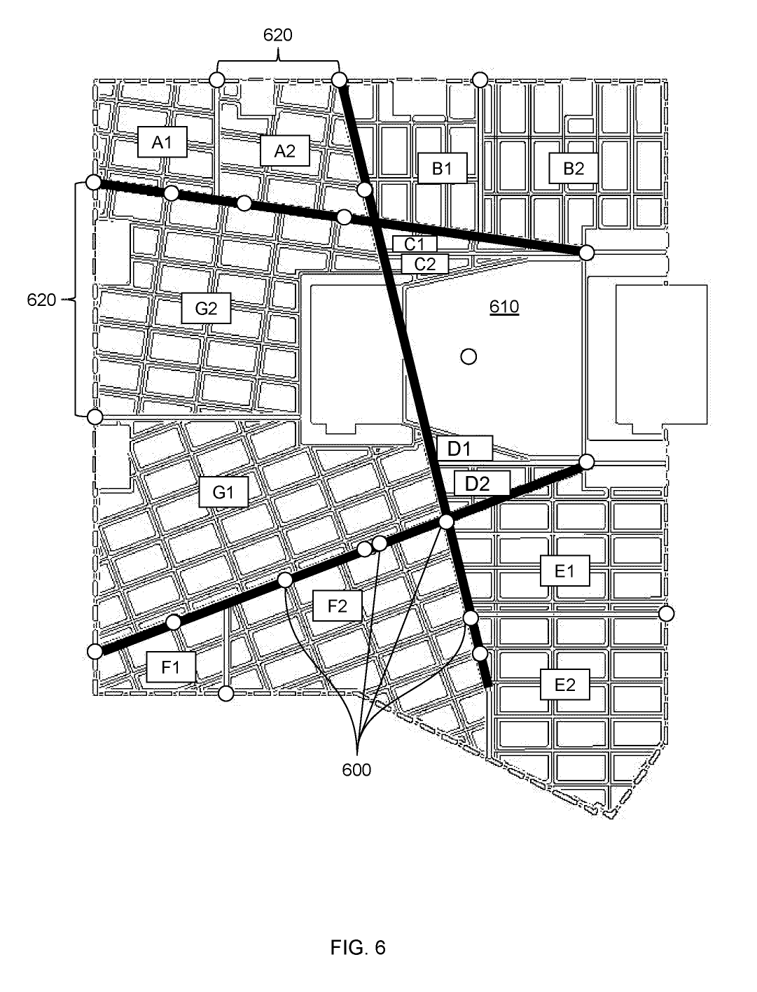

FIG. 6 illustrates how program seed points are assigned to the cells of FIG. 5, according to various embodiments. As shown, design engine 120 generates seed points 600 along major pathways 400, seed point 610 within designated program space 320, and seed points 330 along the outer boundary of design plan 300. Each seed point resides within a parent cell and corresponds to the location of a major program. Each major program generally has specific space requirements. For a given seed point and associated parent cell, design engine 120 performs a procedure to merge the parent cell with one or more neighboring cells in order to meet program space requirements. This procedure is described in greater detail below.

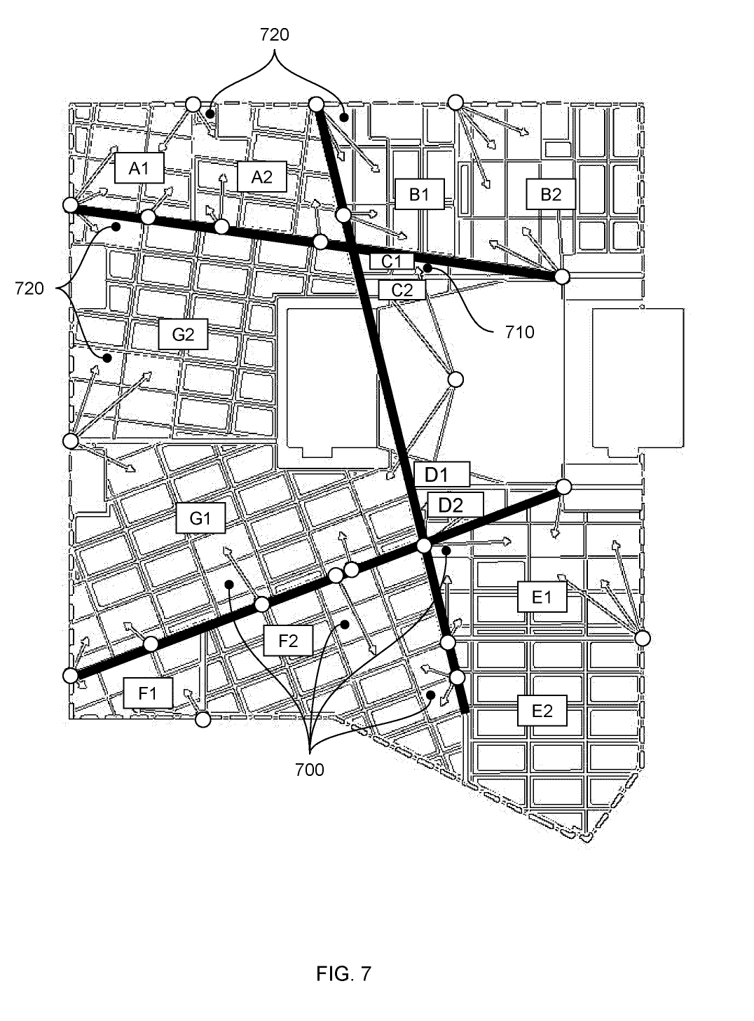

FIG. 7 illustrates how cells are merged based on the program seed points of FIG. 6, according to various embodiments. As shown, via the merging process mentioned above, parent cells of major programs residing along major pathway 400 are merged with adjacent cells 700 to form larger blocks of cells. Similarly, designated program space 320 is merged with adjacent cells 710 to form a larger block of cells, and designated program spaces 340 are merged with adjacent cells 720 to form larger blocks of cells. Each of these larger blocks of cells meets the space requirements of the associated major program.

To perform the merging process for a given seed point, design engine 120 first identifies the parent cell where the seed point resides. Design engine 120 then identifies all cells neighboring that parent cell. Design engine 120 selects a neighboring cell that, when merged with the parent cell, brings the resultant cell area to minimally meet or exceed program space requirements. If no such neighboring cell is found, the largest cell is selected for merging and the process repeats until the total merged space meets the space requirements. When performing this merging process, design engine 120 implements a data structure that supports fast subdivision of geometric spaces, as described in greater detail below in conjunction with FIGS. 10-14. Following cell merging, design engine 120 then distributes minor programs to the remaining unoccupied cells.

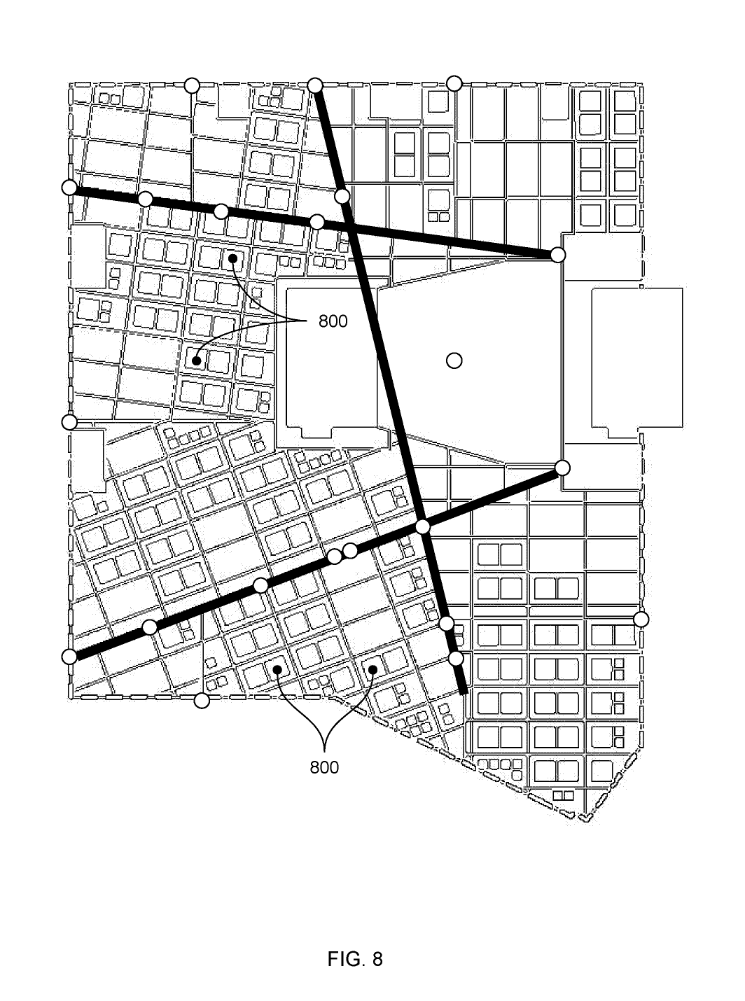

FIG. 8 illustrates how minor programs are distributed within non-merged cells of FIG. 7 to generate a design option, according to various embodiments. As shown, minor programs 800 are distributed throughout the remaining unoccupied cells of design plan 300. In this manner, design engine 120 finalizes design plan 300 to produce a design option 142.

Design engine 120 implements the process described in conjunction with FIGS. 1-8 iteratively with different sets of parameters to generate numerous design options, thereby exploring the design space associated with design problem 122. With each iteration, design engine 120 evaluates generated design options based on various metrics to inform and guide additional iterations. Through many such iterations, design engine 120 may optimize the various metrics with respect to design objectives 124 and design constraints 126. FIG. 9 illustrates the above approach as a series of steps.

### Procedure for Automatically Generating a Design Option

FIG. 9 is a flow diagram of method steps for automatically generating design options to address a design problem, according to various embodiments. Although the method steps are described in conjunction with the systems of FIGS. 1-8, persons skilled in the art will understand that any system may be configured to perform the method steps in any order.

As shown, a method 900 begins at step 902, where design engine 120 processes a set of design objectives and design constraints to generate an initial design plan. The initial design plan outlines a boundary within which geometry is created to address a design problem. At step 904, design engine 120 identifies generative regions and non-generative regions within the design plan. Generative regions include areas where pathways and programs can be placed, while non-generative regions include areas where pathways and programs cannot be placed or have already been designated for placement.

At step 906, design engine 120 generates a set of pathways that divide the design plan into multiple parcels. In doing so, design engine 120 projects line segments from each ingress/egress route across the design plan to an opposing boundary. Design engine 120 may also generate branches from these initially generated pathways. The overall generation of pathways occurs according to set of M parameters that describe how line segments are projected and how branching occurs. In one embodiment, design engine 120 implements a novel data structure to perform the subdivision of design plan into parcels. At step 908, design engine 120 divides each parcel to produce a collection of cells. Design engine 120 projects a rectangular grid across each parcel aligned to the longest boundary of the parcel.

At step 910, design engine 120 assigns major programs to a subset of cells generated at step 908. In doing so, design engine 120 generates a seed point for each major program that resides within a parent cell. Design engine 120 positions these seed points based on a set N parameters that guide seed placement. At step 912, for each cell in the subset, design engine 120 merges the cell with one or more adjacent cells until the merged cells meet a space requirement associated with program corresponding to the cell. In one embodiment, design engine 120 implements the data structure mentioned above to merge cells together. At step 914, design engine 120 distributes minor programs to any remaining unoccupied cells in the design plan to generate a design option.

Design engine 120 performs the above process iteratively and with different sets of the M and N parameters mentioned above in order to generate numerous design options, thereby exploring potentially vast areas of the M+N dimensional design space. Accordingly, the design space can be explored without being artificially constrained by habitual design decisions, as often occurs with conventional approaches. In addition, design engine 120 can generate a wide variety of design options, thereby avoiding the phenomenon of “design fixation.”

### Rapid Subdivision and Merging of Geometric Spaces

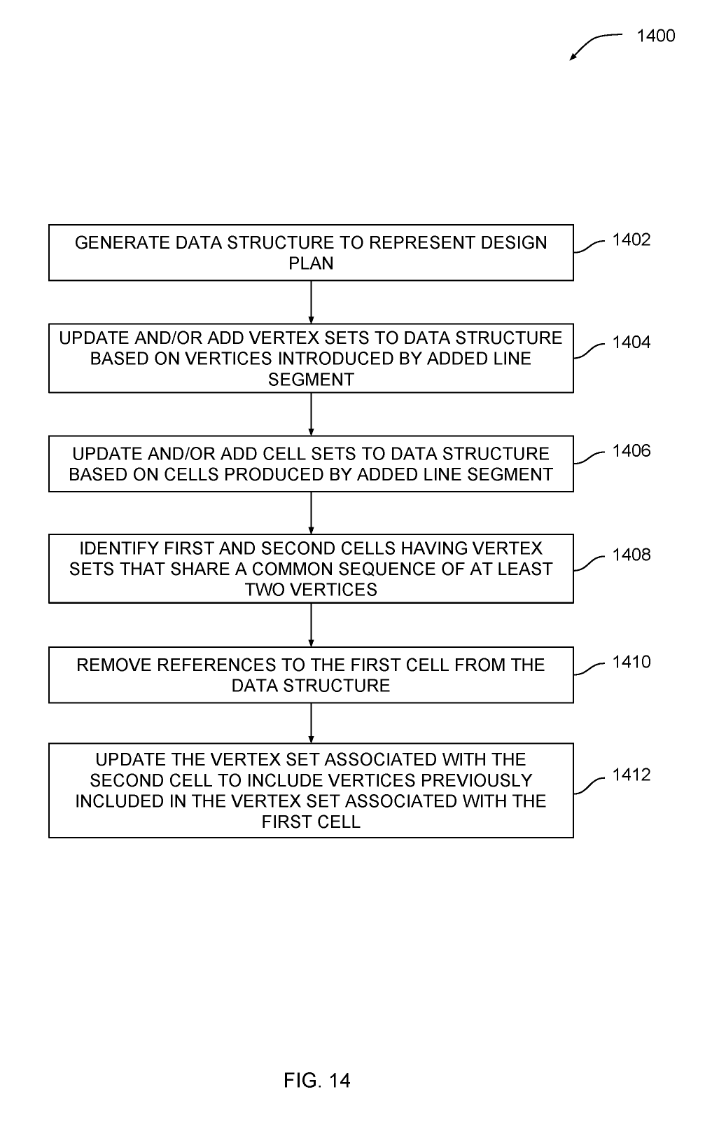

As discussed above in conjunction with FIGS. 3-8, when generating geometry associated with a design option, design engine 120 implements a novel data structure that allows rapid and computationally efficient operations to be performed relative to geometric spaces. This data structure allows a geometric space, such as design plan 300, to be subdivided into smaller portions, including the parcels and cells discussed previously. In addition, the data structure allows such portions to be merged with adjacent portions. Design engine 120 can perform both of these operations using the disclosed data structure and without performing costly geometric operations. Accordingly, the disclosed data structure and the various operations performed relative to that data structure represent an important technological advancement compared to conventional techniques for subdividing and merging geometric spaces. FIGS. 10-13 illustrate how an exemplary data structure is transformed to achieve subdivision and merging of an exemplary geometric space. FIG. 14 sets forth specific steps performed when implementing these operations.

FIG. 10 illustrates a data structure that defines cells within an initial design plan, according to various embodiments. As shown, exemplary design plan 1000 includes vertices V0, V1, V2, V3, V4, and V5. Vertices V0, V2, V3, and V5 define corners of a rectangle. Vertices V1 and V4 reside along edges of design plan 1000 and are coupled together by a line segment that divides design plan 1000 into cells C0 and C1.

As also show, a data structure 1010 indicates, for any given cell of design plan 1000, a set of vertices associated with the cell. For cell C0, data structure 1010 indicates a vertex set [V0, V1, V4, and V5], while for cell C1, data structure 1010 indicates a vertex set [V1, V2, V3, V4]. Vertices in vertex sets are generally ordered with counterclockwise ordering. Data structure 1010 also indicates, for any given vertex of design plan 1000, a set of cells associated with the vertex. For vertex V0, data structure 1010 indicates a cell set [C0], for vertex V1, data structure 1010 indicates a cell set [C0, C1], for vertex V2, data structure 1010 indicates a cell set [C1], and so forth for each vertex in the manner shown.

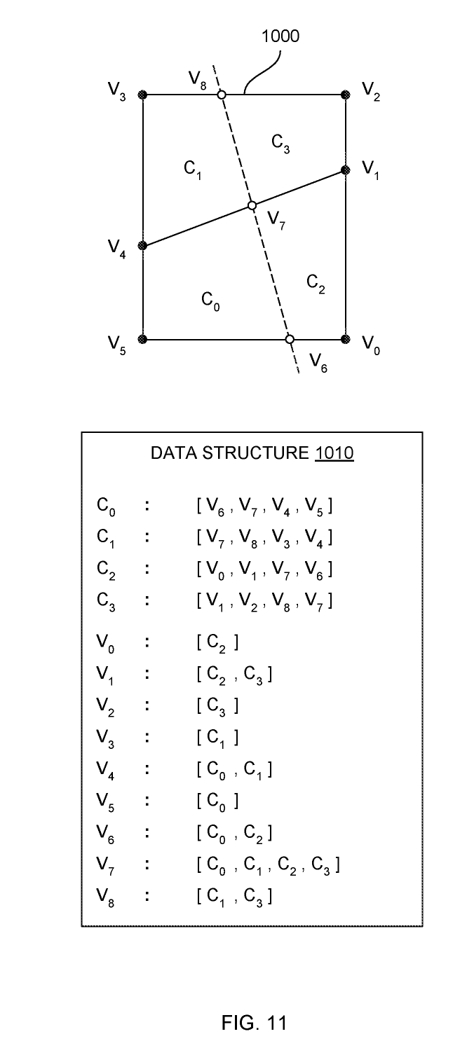

Design engine 120 is configured to manipulate the geometry of design plan 1000 by performing transformations with data structure 1010. When performing a given transformation, design engine 120 adds or removes vertices from vertex sets and/or removes cells from cell sets. In this manner, design engine 120 can subdivide or merge portions of design plan 1000, via transformation of data structure 1010, without performing costly geometric operations with design plan 1000 itself. FIG. 11 illustrates how design engine 120 subdivides design plan 1000.

FIG. 11 illustrates how the data structure of FIG. 10 is modified in order to subdivide a design plan, according to various embodiments. As shown, design plan 1000 includes additional vertices V6, V7, and V8. These additional vertices reside along a line segment that transects design plan 1000 to form cells C0, C1, C2, and C3. Design engine 120 could create this line segment, for example, when placing a pathway. Design engine 120 places the line segment and then computes, via a cost-efficient line intersection operation, the coordinates of the additional vertices.

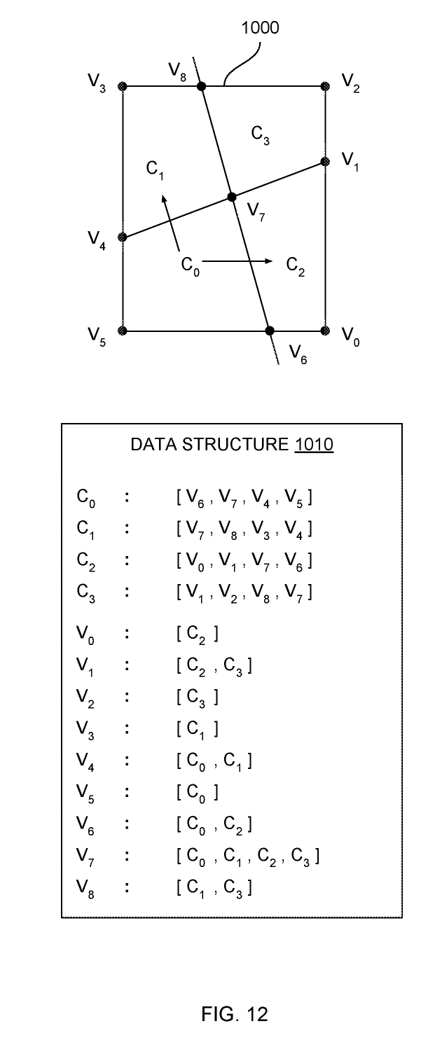

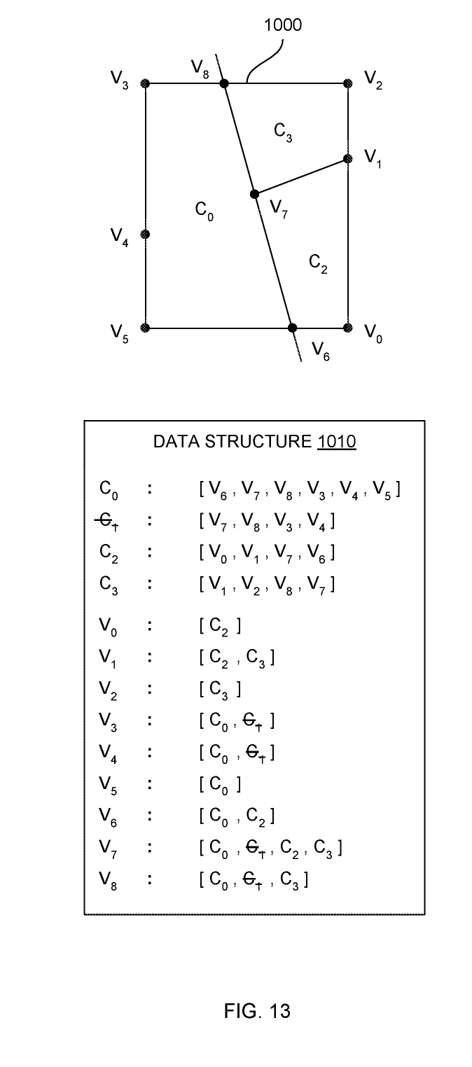

Design engine 120 updates data structure 1010 to represent the revised geometry of design plan 1000. In particular, design engine 1010 modifies the vertex sets associated with cells C0 and C1 to include the appropriate vertices. For example, for cell C0 design engine 120 would remove vertices V0 and V1 from the associated vertex set and add vertices V6 and V7, as is shown. Design engine 120 also adds new vertex sets for newly added cells C2 and C3. Design engine 120 then modifies the cells sets associated with vertices V0 through V5 to include the appropriate cells. For example, for vertex V0 design engine 120 would remove cell C0 from the associated cell set and add cell C2. Design engine 120 also adds new cell sets for newly added vertices V6 through V8. Based on this updated version of data structure 1010, design engine 120 can merge adjacent cells efficiently using the operations described below in conjunction with FIGS. 12-13.

FIG. 12 illustrates how the neighbors of a cell are detected based on the data structure of FIG. 11, according to various embodiments. As shown, design engine 120 determines that cells C1 and C3 are neighbors of cell C0. A “neighbor,” as referred to herein, refers to any geometric shape sharing at least one edge with another geometric shape. Design engine 120 determines that any two cells are neighbors upon detecting, within the vertex sets for those two cells, the same sequence of vertices. Because vertices are ordered with counterclockwise ordering, that sequence of vertices will be presented in reverse order within one of those vertex sets.

In the example shown, design engine 120 determines that cells C0 and C2 are neighbors because the vertex set for cell C0 includes vertex V6 followed by vertex V7 and the vertex set for cell C2 includes vertex V7 followed by vertex V6. Design engine 120 may also identify common sequences of vertices within vertex sets when a given sequence of two or more vertices is split at the boundary of the vertex set. For example, the vertex set for cell C0 includes vertex V7 followed by vertex V4, while the vertex set for cell C1 includes vertex V4 residing at the last position of that vertex set and vertex V7 residing at the first position of the vertex set. Generally, design engine 120 interprets vertex sets as wrapping around from the last position to the first position. Once design engine 120 determines the neighbors of cell C0, design engine 120 may then merge that cell with one or more of those neighboring cells via additional transformation of data structure 1010.

FIG. 13 illustrates how the data structure of FIG. 12 is modified in order to merge one cell with another cell, according to various embodiments. As shown, design engine 120 merges cells C0 and C1 to form a larger cell C0. Cell C0 is associated with vertices V0 through V8. Design engine 120 updates data structure 1010 to represent this new configuration of cells and vertices by removing all references to cell C1. Design engine 120 also adds any vertices previously associated with cell C1 to the vertex set corresponding to cell C0.

Referring generally to FIGS. 10-13, the data structure and associated operations discussed above reduce or eliminate the need to perform costly geometric operations when dividing and merging geometric spaces. Accordingly, design engine 120 can generate geometry for a given design option quickly and efficiently, thereby allowing the design space associated with the design problem to be explored more rapidly and more exhaustively compared to conventional techniques.

### Procedure for Rapidly Subdividing and Merging Geometric Spaces

FIG. 14 is a flow diagram of method steps for allocating space to programs within a design plan, according to various embodiments. Although the method steps are described in conjunction with the systems of FIGS. 1-14, persons skilled in the art will understand that any system may be configured to perform the method steps in any order.

As shown, a method 1400 begins at step 1402, where design engine 120 generates a data structure to represent a design plan. Design engine 120 identifies vertices and cells within that design plan, and then generates vertex sets and cell sets within the data structure. At step 1404, design engine 120 updates and/or adds vertex sets to the data structure based on vertices introduced by the added line segment. At step 1406, design engine 120 updates and/or adds cell sets to the data structure based on cells produced by the added line segment.

At step 1406, design engine 120 identifies first and second cells having vertex sets that share a common sequence of at least two vertices. Because the data structure stores vertices in vertex sets in counterclockwise order, the sequence is reversed between the two vertex sets. Design engine 120 merges the two cells by implementing steps 1410 and 1412. At step 1410, design engine 120 removes references to the first cell from the data structure. At step 1412, design engine 120 updates the vertex set associated with the second cell to include vertices previously included in the vertex set associated with the first cell.

Design engine 120 implements the method 1400 when dividing design plan 300 into macro-regions, dividing those macro-regions to create parcels, and subdividing those parcels into cells. Design engine 120 also implements the method 1400 when merging cells together to allocate space for programs. In performing the merging operation, design engine 120 may compute the area of newly merged cells to determine whether space requirements are met, and also compute the area of neighboring cells in order to select a cell for merging. Via the method 1400, design engine 120 conserves computational resources and increases the speed of convergence when optimizing design options, thereby conferring a significant technological advantage compared to conventional techniques.

In sum, a design engine generates a spectrum of design options to solve an architectural design problem. When generating a given design option, the design engine processes a set of design objectives and design constraints to generate an initial design plan. The initial design plan defines generative regions where geometry can be created and non-generative regions where geometry creation is restricted. The design engine generates a set of pathways that divide the design plan into multiple parcels and then divides each parcel further to produce a collection of cells. The design engine selects specific cells for major programs and merges these cells with adjacent cells until program space requirements are met. The design engine distributes minor programs within the remaining unoccupied cells of the design plan, thereby producing the design option. To perform the above-described division and merging operations, the design engine implements a novel data structure that permits rapid subdivision and merging of geometrical spaces without performing computationally costly geometry operations.

At least one advantage of the techniques described above is that the design engine does not implement conventional heuristics and therefore avoids making early design decisions that overly constrain the design space. Accordingly, the design engine can explore the design space associated with the design problem more exhaustively compared to prior art techniques. In addition, because the design engine does not implement conventional heuristics, the design engine avoids producing overly similar designs that may be ill suited for the diverse types of problems typically found in architecture. These advantages represent substantial technological improvements over prior art approaches to design exploration.

Any and all combinations of any of the claim elements recited in any of the claims and/or any elements described in this application, in any fashion, fall within the contemplated scope of the present embodiments and protection.

1. Some embodiments include a computer-implemented method for redistributing space in an architectural design to meet a set of design criteria, the method comprising: dividing a model of a first architectural design to produce a first region that is bounded, at least in part, by a first set of vertices, and a second region that is bounded, at least in part, by a second set of vertices; generating a first data structure indicating that the first set of vertices corresponds to the first region and the second set of vertices corresponds to the second region; identifying, based on the data structure, that the first region shares at least one edge with the second region; and incorporating the second set of vertices into the first set of vertices to merge the second region into the first region, wherein a combined area of the first region and the second region exceeds a first area threshold.

2. The computer-implemented method of clause 1, wherein dividing the model of the first architectural design comprises projecting a first line segment across the model, and wherein the first line segment intersects at least one vertex included in the first set of vertices and at least one vertex included in the second set of vertices.

3. The computer-implemented method of any of clauses 1, and 2, wherein identifying that the first region shares at least one edge with the second region comprises: determining that the first set of vertices includes a first sequence of vertices; and determining that the first set of vertices is associated with a second sequence of vertices that is included in the second set of vertices.

4. The computer-implemented method of any of clauses 1, 2, and 3, wherein the first sequence of vertices comprises a reverse ordering of the second sequence of vertices.

5. The computer-implemented method of any of clauses 1, 2, 3, and 4, wherein the first set of vertices comprises a counterclockwise ordering of all vertices at least partially bounding the first region, and the second set of vertices comprises a counterclockwise ordering of all vertices at least partially bounding the second region.

6. The computer-implemented method of any of clauses 1, 2, 3, 4, and 5, wherein merging the second region into the first region expands the first region to produce an expanded first region, and further comprising updating the model of the first architectural design to replace the first region and the second region with the expanded first region.

7. The computer-implemented method of any of clauses 1, 2, 3, 4, 5, and 6, wherein the first data structure indicates, for a first vertex included in at least one of the first set of vertices and the second set of vertices, a first set of regions at least partially bounded by the first vertex.

8. The computer-implemented method of any of clauses 1, 2, 3, 4, 5, 6, and 7, wherein the first vertex is included in both the first set of vertices and the second set of vertices, and further comprising modifying the first set of regions to remove the second region.

9. The computer-implemented method of any of clauses 1, 2, 3, 4, 5, 6, 7, and 8, further comprising incorporating a third set of vertices into a fourth set of vertices to merge a third region into a fourth region, thereby producing the first region.

10. The computer-implemented method of any of clauses 1, 2, 3, 4, 5, 6, 7, 8, and 9, wherein the combined area of the third region and the fourth region does not exceed the first area threshold.

11. Some embodiments include a non-transitory computer-readable medium storing program instructions that, when executed by a processor, cause the processor to redistribute space in an architectural design to meet a set of design criteria by performing the steps of: dividing a model of a first architectural design to produce a first region that is bounded, at least in part, by a first set of vertices, and a second region that is bounded, at least in part, by a second set of vertices; generating a first data structure indicating that the first set of vertices corresponds to the first region and the second set of vertices corresponds to the second region; identifying, based on the data structure, that the first region shares at least one edge with the second region; and incorporating the second set of vertices into the first set of vertices to merge the second region into the first region, wherein a combined area of the first region and the second region exceeds a first area threshold.

12. The non-transitory computer-readable medium of clause 11, wherein the step of dividing the model of the first architectural design comprises projecting a first pathway across the model between a first boundary of the model and a first ingress/egress route within the model, and wherein the first line segment intersects at least one vertex included in the first set of vertices and at least one vertex included in the second set of vertices.

13. The non-transitory computer-readable medium of any of clauses 11 and 12, wherein the step of identifying that the first region shares at least one edge with the second region comprises: determining that the first set of vertices includes a first sequence of vertices; and determining that the first set of vertices is associated with a second sequence of vertices that is included in the second set of vertices, wherein the first sequence of vertices comprises a reverse ordering of the second sequence of vertices.

14. The non-transitory computer-readable medium of any of clauses 11, 12, and 13, wherein at least one of the first sequence of vertices and the second sequence of vertices is separated into two sub-sequences by an array boundary.

15. The non-transitory computer-readable medium of any of clauses 11, 12, 13, and 14, wherein the first set of vertices comprises a counterclockwise ordering of all vertices at least partially bounding the first region, and the second set of vertices comprises a counterclockwise ordering of all vertices at least partially bounding the second region.

16. The non-transitory computer-readable medium of any of clauses 11, 12, 13, 14, and 15, wherein the step of merging the second region into the first region expands the first region to produce an expanded first region, and further comprising updating the model of the first architectural design to replace the first region and the second region with the expanded first region.

17. The non-transitory computer-readable medium of any of clauses 11, 12, 13, 14, 15, and 16, wherein the first data structure indicates, for a first vertex included in at least one of the first set of vertices and the second set of vertices, a first set of regions at least partially bounded by the first vertex.

18. The non-transitory computer-readable medium of any of clauses 11, 12, 13, 14, 15, 16, and 17, wherein the first vertex is included in both the first set of vertices and the second set of vertices, and further comprising modifying the first set of regions to remove the second region.

19. The non-transitory computer-readable medium of any of clauses 11, 12, 13, 14, 15, 16, 17, and 18, further comprising the step of incorporating a third set of vertices into a fourth set of vertices to merge a third region into a fourth region, wherein the combined area of the third region and the fourth region does not exceed the first area threshold.

20. Some embodiments include a system, comprising: a memory storing a design engine; and a processor that, when executing the design engine, is configured to perform the steps of: dividing a model of a first architectural design to produce a first region that is bounded, at least in part, by a first set of vertices, and a second region that is bounded, at least in part, by a second set of vertices; generating a first data structure indicating that the first set of vertices corresponds to the first region and the second set of vertices corresponds to the second region; identifying, based on the data structure, that the first region shares at least one edge with the second region; and incorporating the second set of vertices into the first set of vertices to merge the second region into the first region, wherein a combined area of the first region and the second region exceeds a first area threshold.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for redistributing space in an architectural design to meet a set of design criteria, the method comprising:
dividing a model of a first architectural design to produce a first region that is bounded, at least in part, by a first set of vertices, and a second region that is bounded, at least in part, by a second set of vertices;
generating a first data structure indicating that the first set of vertices corresponds to the first region and the second set of vertices corresponds to the second region;
identifying, based on the data structure, that the first region shares at least one edge with the second region; and
incorporating the second set of vertices into the first set of vertices to merge the second region into the first region, wherein a combined area of the first region and the second region exceeds a first area threshold.

2. The computer-implemented method of claim 1, wherein dividing the model of the first architectural design comprises projecting a first line segment across the model, and wherein the first line segment intersects at least one vertex included in the first set of vertices and at least one vertex included in the second set of vertices.

3. The computer-implemented method of claim 1, wherein identifying that the first region shares at least one edge with the second region comprises:
determining that the first set of vertices includes a first sequence of vertices; and
determining that the first set of vertices is associated with a second sequence of vertices that is included in the second set of vertices.

4. The computer-implemented method of claim 3, wherein the first sequence of vertices comprises a reverse ordering of the second sequence of vertices.

5. The computer-implemented method of claim 1, wherein the first set of vertices comprises a counterclockwise ordering of all vertices at least partially bounding the first region, and the second set of vertices comprises a counterclockwise ordering of all vertices at least partially bounding the second region.

6. The computer-implemented method of claim 1, wherein merging the second region into the first region expands the first region to produce an expanded first region, and further comprising updating the model of the first architectural design to replace the first region and the second region with the expanded first region.

7. The computer-implemented method of claim 1, wherein the first data structure indicates, for a first vertex included in at least one of the first set of vertices and the second set of vertices, a first set of regions at least partially bounded by the first vertex.

8. The computer-implemented method of claim 7, wherein the first vertex is included in both the first set of vertices and the second set of vertices, and further comprising modifying the first set of regions to remove the second region.

9. The computer-implemented method of claim 1, further comprising incorporating a third set of vertices into a fourth set of vertices to merge a third region into a fourth region, thereby producing the first region.

10. The computer-implemented method of claim 9, wherein the combined area of the third region and the fourth region does not exceed the first area threshold.

11. A non-transitory computer-readable medium storing program instructions that, when executed by a processor, cause the processor to redistribute space in an architectural design to meet a set of design criteria by performing the steps of:
dividing a model of a first architectural design to produce a first region that is bounded, at least in part, by a first set of vertices, and a second region that is bounded, at least in part, by a second set of vertices;
generating a first data structure indicating that the first set of vertices corresponds to the first region and the second set of vertices corresponds to the second region;
identifying, based on the data structure, that the first region shares at least one edge with the second region; and
incorporating the second set of vertices into the first set of vertices to merge the second region into the first region, wherein a combined area of the first region and the second region exceeds a first area threshold.

12. The non-transitory computer-readable medium of claim 11, wherein the step of dividing the model of the first architectural design comprises projecting a first pathway across the model between a first boundary of the model and a first ingress/egress route within the model, and wherein the first line segment intersects at least one vertex included in the first set of vertices and at least one vertex included in the second set of vertices.

13. The non-transitory computer-readable medium of claim 11, wherein the step of identifying that the first region shares at least one edge with the second region comprises:
determining that the first set of vertices includes a first sequence of vertices; and
determining that the first set of vertices is associated with a second sequence of vertices that is included in the second set of vertices, wherein the first sequence of vertices comprises a reverse ordering of the second sequence of vertices.

14. The non-transitory computer-readable medium of claim 13, wherein at least one of the first sequence of vertices and the second sequence of vertices is separated into two sub-sequences by an array boundary.

15. The non-transitory computer-readable medium of claim 11, wherein the first set of vertices comprises a counterclockwise ordering of all vertices at least partially bounding the first region, and the second set of vertices comprises a counterclockwise ordering of all vertices at least partially bounding the second region.

16. The non-transitory computer-readable medium of claim 11, wherein the step of merging the second region into the first region expands the first region to produce an expanded first region, and further comprising updating the model of the first architectural design to replace the first region and the second region with the expanded first region.

17. The non-transitory computer-readable medium of claim 11, wherein the first data structure indicates, for a first vertex included in at least one of the first set of vertices and the second set of vertices, a first set of regions at least partially bounded by the first vertex.

18. The non-transitory computer-readable medium of claim 17, wherein the first vertex is included in both the first set of vertices and the second set of vertices, and further comprising modifying the first set of regions to remove the second region.

19. The non-transitory computer-readable medium of claim 1, further comprising the step of incorporating a third set of vertices into a fourth set of vertices to merge a third region into a fourth region, wherein the combined area of the third region and the fourth region does not exceed the first area threshold.

20. A system, comprising:
a memory storing a design engine; and
a processor that, when executing the design engine, is configured to perform the steps of:
dividing a model of a first architectural design to produce a first region that is bounded, at least in part, by a first set of vertices, and a second region that is bounded, at least in part, by a second set of vertices;
generating a first data structure indicating that the first set of vertices corresponds to the first region and the second set of vertices corresponds to the second region;
identifying, based on the data structure, that the first region shares at least one edge with the second region; and
incorporating the second set of vertices into the first set of vertices to merge the second region into the first region, wherein a combined area of the first region and the second region exceeds a first area threshold.
